(19) United States
(12) Patent Application Publication
(10) Pub. No.: US 2009/0225962 A1
(43) Pub. Date: Sep. 10, 2009

(54) INTERACTIVE VOICEMAIL MESSAGE SELECTION TO REFUSE AN INCOMING CALL

(75) Inventors: Kevin M. Corry, Pflugerville, TX (US); Mark A. Peloquin, Austin, TX (US); Steven Pratt, Leander, TX (US); Karl M. Rister, Austin, TX (US); Andrew M. Theurer, Austin, TX (US)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(73) Assignee: International Business Machines Corporation, Armonk, NY (US)

(21) Appl. No.: 12/043,989

(22) Filed: Mar. 7, 2008

(51) Int. Cl. H04M 11/00; H04M 1/64

(52) U.S. Cl. 379/88.18; 379/88.12; 379/88.11

(57) ABSTRACT

An interactive voicemail selection system to refuse an incoming call is provided. A user indicates a specific voicemail message to be played to a calling party. A call is received in a recipient device, from a calling party. The call comprises an identification of a calling party. An identification of the calling party is displayed on a display of the recipient device. An indication is received from the recipient that identifies the specific prerecorded voicemail message, from a plurality of prerecorded voicemail messages, that is to be played to the calling party. An identifier associated with the specific prerecorded voicemail message is sent to a voicemail system in order for the specific prerecorded message associated with the selected identifier to be played to the calling party.

### BACKGROUND OF THE INVENTION

1. Field of The Invention

The present application relates generally to an improved data processing system and method. More specifically, the present application is directed to a system and method for interactive voicemail selection to refuse an incoming call.

2. Background of the Invention

Developers are constantly incorporating more and more features and technology into telecommunication systems. In fact, telecommunication systems have advanced tremendously in recent years. For example, wireless devices use a variety of digital modulation techniques, Code Division Multiple Access (CDMA), Global System for Mobile Communications (GSM), General Packet Radio Service (GPRS), and Enhanced Data Rates for Global Evolution (EDGE). Regardless of modulation technique, wireless devices have a myriad of features, such as electronic phonebooks, speed dialing, single button voicemail access, and messaging capabilities. These are only a sample of features that are capable of, or have already been implemented into, telecommunication systems. A particularly useful feature provides voicemail, which is a centralized system of managing telephone messages for a user.

Voicemail is often associated with office telephone systems or PBXs. However, voicemail may also be associated with public telephone network services such as residential phones or cell phones. Voicemail is a means used by a recipient to answer a caller when the recipient is either not able to or does not want to answer the phone. If the caller leaves a message, voicemail allows the recipient to retrieve, send, and manage those voice messages 24 hours a day, 7 days a week from any tone dial telephone in the world.

### BRIEF SUMMARY OF THE INVENTION

In one illustrative embodiment, a method, in a data processing system, is provided for indicating a specific voicemail message to be played to a calling party. The illustrative embodiments receive, in a recipient device, a call from a calling party. In the illustrative embodiments, the call comprises an identification of a calling party. The illustrative embodiments display, on a display of the recipient device, the identification of the calling party to a recipient. The illustrative embodiments receive an indication from the recipient that identifies the specific prerecorded voicemail message, from a plurality of prerecorded voicemail messages, that is to be played to the calling party. The illustrative embodiments send an identifier associated with the specific prerecorded voicemail message to a voicemail system in order for the specific prerecorded message associated with the selected identifier to be played to the calling party.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the exemplary embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an exemplary diagram of a system of communication networks and communication devices in which exemplary aspects of the illustrative embodiments may be implemented;

FIG. 2 is an exemplary block diagram of a communication device in which exemplary aspects of the illustrative embodiments may be implemented;

FIG. 3 is an exemplary block diagram of the primary operational elements of a communication system in accordance with one illustrative embodiment;

FIG. 4 is an exemplary flow diagram of the operation of selecting a specific voicemail message using a recipient communication device in accordance with one illustrative embodiment; and

FIG. 5 is an exemplary flow diagram of the operation of identifying a specific voicemail message to be presented to a caller by a voicemail system in accordance with one illustrative embodiment.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, radio frequency (RF), etc.

Computer program code for carrying out operations of the present invention may be written in any combination of one or more programming languages, including an object oriented programming language such as Java™, Smalltalk™, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The illustrative embodiments are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the illustrative embodiments are described with regard to using a cellular telephone or cell phone to characterize the operation of a mechanism that indicates a specific voicemail message to be played to a caller based on input from the recipient, the illustrative embodiments are not limited to such. Rather, any mechanism capable of displaying the identification of a caller and receiving an indication from the recipient of a specific one of a group of voicemail messages to play to the caller may be used without departing from the spirit and scope of the present invention.

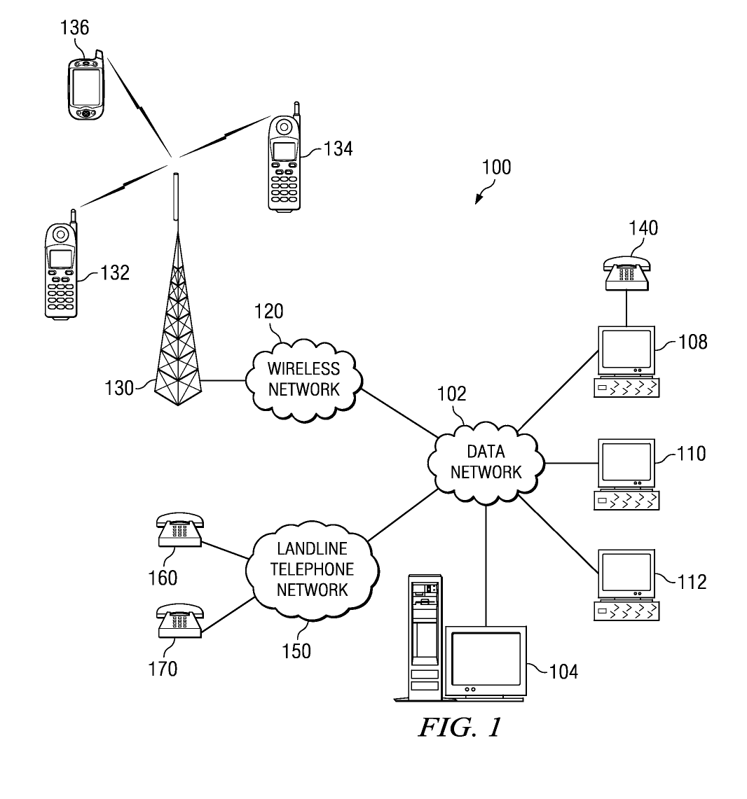

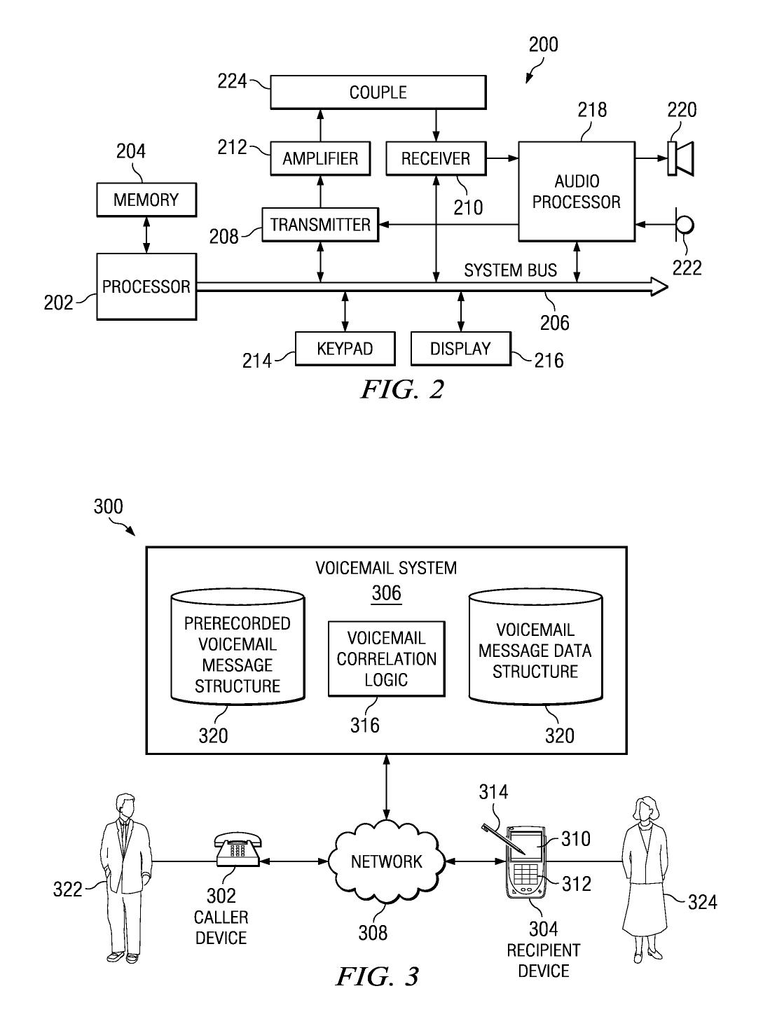

The illustrative embodiments provide mechanisms for indicating a specific voicemail message to be played to a caller based on a selection of the specific voicemail message from a group of voicemail messages by the recipient of the call. As such, the mechanisms of the illustrative embodiments are especially well suited for implementation within a communication environment and within, or in association with, communication devices, such as communication switches, client devices, voicemail systems, and the like. In order to provide a context for the description of the mechanisms of the illustrative embodiments, FIGS. 1 and 2 are provided hereafter as examples of a communication system, or environment, and a communication device, in which, or with which, the mechanisms of the illustrative embodiments may be implemented. It should be appreciated that FIGS. 1 and 2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 is an exemplary diagram of a system of communication networks and communication devices in which exemplary aspects of the illustrative embodiments may be implemented. As shown in FIG. 1, system 100 includes a plurality of networks 102, 120, and 150. In particular, data network 102, wireless network 120, and landline telephone network 150 are depicted. It should be noted that while only these three types of networks are depicted in FIG. 1, the present invention is not limited to only these types of networks or does not require the inclusion of all of these types of networks. Other types of communication networks may be used in addition to or in replacement of one or more of depicted networks 102, 120, and 150 without departing from the spirit and scope of the present invention.

Data network 102 may comprise one or more networks of the same or different types. For example, data network 102 may comprise one or more local area networks (LANs), wide area networks (WANs), the Internet, and the like. Similarly, wireless network 120 and landline telephone network 150 may comprise one or more networks of the same or different types. Essentially, any number and type or combination of types of communication networks may be used with the illustrative embodiments without departing from the spirit and scope of the present invention.

Each network 102, 120, and 150 has one or more communication devices coupled to it through either wired or wireless communication links. For example, data network 102 has server 104 and client devices 108-112 coupled to it via communication links generally known in the art. In addition, client device 108 has associated telephone communication device 140 which communicates with other wired or wireless telephone devices via client device 108 and data network 102, e.g., via Internet telephony. Client devices 108-112 and/or telephone communication device 140 preferably have the capability to perform one or more of voice telephone communications, electronic mail message communications, instant text message communications, and the like.

Wireless network 120 has a plurality of wireless communication devices 132, 134, and 136 which communicate via wireless network 120 through wireless communication point 130, e.g., a cellular base station, wireless access point, or the like. Wireless communication devices 132, 134, and 136 may be, for example, wireless telephones, personal digital assistants, pagers, or the like. Wireless communication devices 132, 134, and 136 preferably have the capability to perform one or more of voice telephone communications, electronic mail message communications, instant text message communications, and the like.

Landline telephone network 150 has a plurality of wired or landline communication devices 160 and 170 coupled to it via wired links as are generally known in the art. As with the other communication devices described above, landline telephone devices 160 and 170 preferably have the capability to perform one or more of voice telephone communications, electronic mail message communications, instant text message communications, and the like.

The various wireless communication devices 132, 134, and 136 and wired communication devices 108-112, 140, 160, and 170 may maintain an associated voicemail data structure on a voicemail system operating on server 104 or client devices 108-112 that answers a caller when the recipient is either not able to or does not want to answer the phone and if the caller leaves a voice message, voicemail allows the recipient to retrieve, send, and manage those voice messages using one of communication devices 108-112, 132-136, 140, 160, or 170.

As mentioned above, the illustrative embodiments provide a mechanism for a recipient to indicate a specific voicemail message to play to a caller based the identification of the caller. When the recipient refuses a call from a caller, the recipient may specify one of a number of prerecorded voicemail messages for the caller to hear. Examples of the prerecorded voicemail message may be “I am in a meeting,” “I am out of the office on vacation,” “Call my secretary,” “Please add me to your do-not-call list,” or any other voicemail message the recipient records. The recipient may also specify the voicemail message by either using a hotkey that is “bound” to the specific message or through an on-screen menu that is displayed on the communication device from which the desired voicemail message may be selected.

FIG. 2 is an exemplary block diagram of a communication device in which exemplary aspects of the illustrative embodiments may be implemented. Communication device 200 includes processor 202 for controlling operation of the communication device and a memory 204. Processor 202 may be a general-purpose microprocessor operating under the control of instructions stored a memory, such as memory 204, or device-specific circuitry for controlling the operation of communication device 200. Processor 202 is connected by system bus 206 to transmitter 208, receiver 210, keypad 214, display 216, and audio processor 218. Keypad 214 may be a keypad and/or buttons. Display 216 may be any type of display device including a liquid crystal display (LCD) or other known displays, such as a cathode ray tube or active matrix display.

Transmitter 208 and receiver 210 are coupled to a communication signal by couple 224 to provide full duplex communication. The communication signal may be provided by a telephone line (not shown) in a land-based telephone or an antenna, such as for a wireless telephone. Audio processor 218 provides basic analog audio outputs to speaker 220 and accepts analog audio inputs from microphone 222. Received signals are demodulated and decoded by receiver 210. Transmitter 208 encodes and modulates signals passed to it by processor 202 or audio processor 218. The output of the transmitter is amplified by power amplifier 212 to control the power level at which the signal is transmitted.

Processor 202 or audio processor 218 may detect audible call status information and call status codes received by receiver 210. Memory 204 may include a lookup table associating call status information or call status codes with visual call status information, such as text messages. Processor 202 detects or receives a call status code and displays an appropriate call status message on display 216. Those of ordinary skill in the art will appreciate that the hardware depicted in FIG. 2 may vary.

The call status message displayed to the recipient on display 216 may be the name and phone number of the caller, just the phone number of the caller, the identifier of “unknown” if the caller does not want their information displayed, or the like. Providing the name and/or phone number or other identification of the caller to the recipient is generally referred to as caller identification or caller ID. The illustrative embodiments provide a mechanism for a recipient to use the caller ID to indicate a specific voicemail message to play to a caller based the identification of the caller.

FIG. 3 is an exemplary block diagram of the primary operational elements of a communication system in accordance with one illustrative embodiment. As shown in FIG. 3, communication system 300 includes caller device 302, recipient device 304, and voicemail system 306 that may be connected via communication network 308. Communication network 308 may be made up of one or more communications networks, such as data network 102, wireless network 120, and landline telephone network 150 of FIG. 1. Recipient device 304 and caller device 302 are communication devices, such as communication device 200 of FIG. 2. As shown above, recipient device 304 may include display 310 and keypad 312.

A call initiated from caller 322 via caller device 302 is transmitted over communication network 308 to recipient 324 via recipient device 304. Recipient device 304 may use information associated with the call to present information associated with caller 322 and the incoming call to recipient 324 on display 3 10. Along with the information associated with the call and caller 322, recipient device 304 may also present on display 310 an identification of one or more prerecorded voicemail messages that recipient 324 may use to answer the call in the event that recipient 324 is predisposed or does not want to answer the call personally.

Using the information presented on display 310, recipient 324 may decide which of the prerecorded voicemail messages for the call to be answered with by voicemail system 306. Recipient 324 may select one of the prerecorded messages using a “hotkey” on keypad 312 that is “bound” to the specific voicemail message, through an on-screen menu that is presented on display 310, by using stylus 314 and selecting the specific voicemail message through a touch pad feature associated with display 310, or the like. Examples of the voicemail message may be “I am in a meeting,” “I am out of the office on vacation,” “Call my secretary,” “Please add me to your do-not-call list,” or any other message the voicemail recipient records.

When recipient 324 indicates the specific voicemail message to be presented to caller 322, recipient device 304 sends a signal to voicemail system 306 that represents the specific voicemail message to be played to caller 322. Voicemail system 306 receives the signal from recipient device 304 and uses voicemail correlation logic 316 to correlate the signal to the specific voicemail message that is to be presented to caller 322. Once voicemail correlation logic 316 determines the correct voicemail message that is to be presented to the caller, voicemail system 306 retrieves the prerecorded voicemail message from prerecorded voicemail message structure 320 and presents the prerecorded voicemail message to caller 322 via caller device 302. If after presenting the prerecorded voicemail message via caller device 302, caller 322 leaves a message for the recipient, voicemail system 306 records the message in voice message data structure 320, which may the be retrieved by recipient 324 at a later time.

Thus, the illustrative embodiments provide mechanisms where the recipient of a call may provide input at the time a call is received to play a specific voicemail message to the caller. When the recipient refuses the call, the recipient may specify one of a number of prerecorded voicemail messages for the caller to hear.

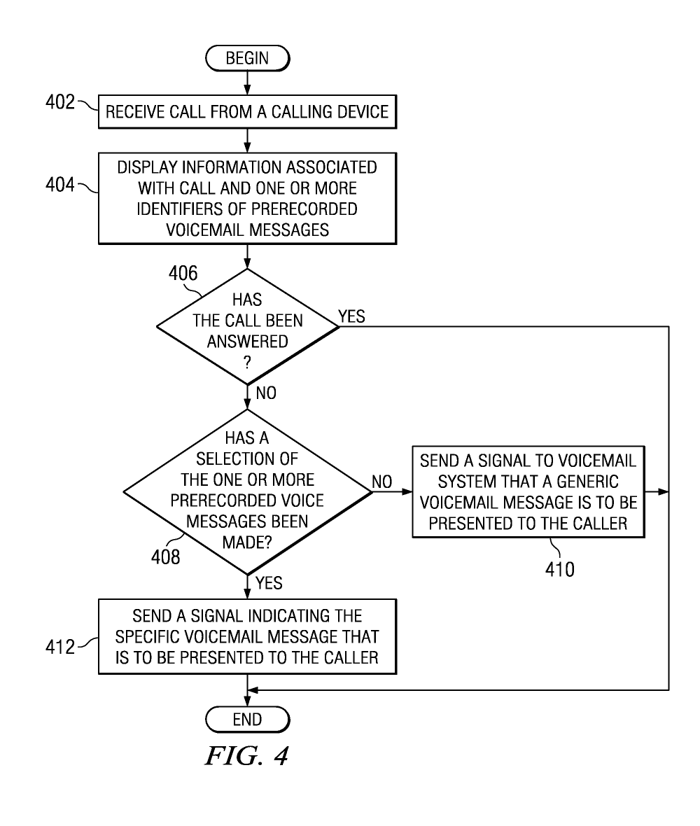

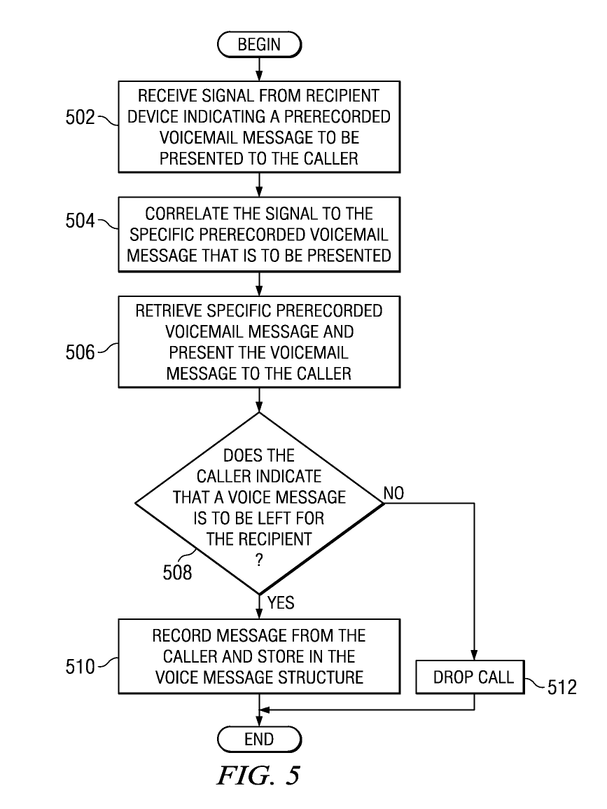

FIGS. 4 and 5 are flowcharts that illustrate the primary operation of a communication system that identifies a specific prerecorded voicemail message to play to a caller according to the invention. FIG. 4 is an exemplary flow diagram of the operation of selecting a specific voicemail message using a recipient communication device in accordance with one illustrative embodiment. As the operation begins, a recipient device receives a call from a calling device (step 402). The recipient device disseminates information associated with the call and presents the information on a display to the recipient along with one or more identifiers of prerecorded messages that may be represented to the caller in the event that the recipient does not want to answer the call (step 404). The recipient device then determines the call is answered by the recipient (step 406). If at step 406 the call is answered, then the operation ends. If at step 406 the call is not answered, then the recipient device determines if a selection was made by the recipient of the one or more prerecorded messages (step 408).

If at step 408 a selection is not made by the recipient, a signal is sent to a voicemail system indicating that a generic voicemail message should be presented to the caller (step 410), with the operation ending thereafter. If at step 408 the user makes a selection of the one or more prerecorded messages, then a signal is sent to a voicemail system indicating the specific voicemail message to be presented to the caller (step 412), with the operation ending thereafter. Thus, when the recipient refuses a call from a caller, the recipient may specify one of a number of prerecorded voicemail messages for the caller to hear.

FIG. 5 is an exemplary flow diagram of the operation of identifying a specific voicemail message to be presented to a caller by a voicemail system in accordance with one illustrative embodiment. As the operation begins, a voicemail system receives a signal and a call that has been transferred from a recipient (step 502). The voicemail system uses the signal from the recipient to determine which of a number of prerecorded voicemail messages should be presented to the caller (step 504). Based on the identification of the specific voicemail message that is to be presented to the caller, the voicemail message retrieves the prerecorded voicemail message from a prerecorded voicemail message data structure and presents the prerecorded voicemail message to the caller (step 506). The voicemail system then determines if the caller intends to leave a voice message for the recipient (step 508). If at step 508 the caller intends to leave a message, the voicemail system records the message in a voice message structure (step 510), with the operation ending thereafter. If at step 508 the caller does not want to leave a message, the voicemail system drops the call (step 512), with the operation ending thereafter.

Thus, the illustrative embodiments provide for a recipient to indicate a specific voicemail message to play to a caller based the identification of the caller. When the recipient refuses a call from a caller, the recipient may specify one of a number of prerecorded voicemail messages for the caller to hear. The recipient may specify the voicemail message by either using a hotkey that is “bound” to the specific message or through an on-screen menu that is displayed on the communication device from which the desired voicemail message may be selected. The indicated prerecorded voicemail message is played to the caller and, if the caller still wants to leave a message, the voicemail system records the message from the caller.

As noted above, it should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for indicating a specific voicemail message to be played to a calling party, the method comprising:
receiving, in a recipient device, a call from a calling party, wherein the call comprises an identification of a calling party;
displaying, on a display of the recipient device, the identification of the calling party to a recipient;
receiving an indication from the recipient that identifies the specific prerecorded voicemail message, from a plurality of prerecorded voicemail messages, that is to be played to the calling party; and
sending an identifier associated with the specific prerecorded voicemail message to a voicemail system in order for the specific prerecorded message associated with the selected identifier to be played to the calling party.

2. The method of claim 1, further comprising:
displaying a plurality of identifiers that identify the plurality of prerecorded voicemail messages to the recipient.

3. The method of claim 1, further comprising:
receiving, in the voicemail system, the identifier associated with the specific prerecorded voicemail message;
correlating the identifier to the specific voicemail message stored in a prerecorded voicemail message data structure;
retrieving the specific voicemail message from the prerecorded voicemail message data structure; and
playing the specific voicemail message to the calling party.

4. The method of claim 3, further comprising:
responsive to playing the specific voicemail message to the calling party, determining if the calling party intends to leave a message for the recipient; and
responsive to an indication that the calling party intends to leave the message, recording the message from the calling party in a voice message data structure.

5. The method of claim 1, wherein the indication is received via at least one of a touch pad indication of an on-screen menu on the recipient device or a hotkey associated with a key on a keypad of the recipient device.

6. The method of claim 1, wherein the indication is received via a hotkey associated with a key on a keypad of the recipient device.

7. The method of claim 1, wherein the identification of the calling party comprises at least one of a telephone number, a name, or a telephone number and a name.

8. The method of claim 1, wherein the recipient device is at least one of a wireless telephone, a personal digital assistant, or a pager.

9. A computer program product comprising a computer useable medium having a computer readable program embodied thereon, wherein the computer readable program, when executed in a data processing system, causes the data processing system to:
receive a call from a calling party, wherein the call comprises an identification of the calling party;
display the identification of the calling party to a recipient;
receive an indication from the recipient that identifies the specific prerecorded voicemail message, from a plurality of prerecorded voicemail messages, that is to be played to the calling party; and
send an identifier associated with the specific prerecorded voicemail message to a voicemail system in order for the specific prerecorded message associated with the selected identifier to be played to the calling party.

10. The computer program product of claim 9, wherein the computer readable program further causes the data processing system to:
display a plurality of identifiers that identify the plurality of prerecorded voicemail messages to the recipient.

11. The computer program product of claim 9, wherein the computer readable program further causes the data processing system to:
receive, in the voicemail system, the identifier associated with the specific prerecorded voicemail message;
correlate the identifier to the specific voicemail message stored in a prerecorded voicemail message data structure;
retrieve the specific voicemail message from the prerecorded voicemail message data structure; and
play the specific voicemail message to the calling party.

12. The computer program product of claim 11, wherein the computer readable program further causes the data processing system to:
responsive to playing the specific voicemail message to the calling party, determine if the calling party intends to leave a message for the recipient; and
responsive to an indication that the calling party intends to leave the message, record the message from the calling party in a voice message data structure.

13. The computer program product of claim 9, wherein the indication is received via at least one of a touch pad indication of an on-screen menu on a recipient device or a hotkey associated with a key on a keypad of the recipient device.

14. The computer program product of claim 9, wherein the indication is received via a hotkey associated with a key on a keypad of a recipient device.

15. A system in a recipient device, comprising:
a processor; and
a memory coupled to the processor, wherein the memory comprises instructions which, when executed by the processor, cause the processor to:
receive, in the recipient device, a call from a calling party, wherein the call comprises an identification of the calling party;
display, on a display of the recipient device, the identification of the calling party to a recipient;
receive an indication from the recipient that identifies the specific prerecorded voicemail message, from a plurality of prerecorded voicemail messages, that is to be played to the calling party; and
send an identifier associated with the specific prerecorded voicemail message to a voicemail system in order for the specific prerecorded message associated with the selected identifier to be played to the calling party.

16. The system of claim 15, wherein the instructions further cause the processor to:
display a plurality of identifiers that identify the plurality of prerecorded voicemail messages to the recipient.

17. The system of claim 15, wherein the instructions further cause the processor to:
receive, in the voicemail system, the identifier associated with the specific prerecorded voicemail message;
correlate the identifier to the specific voicemail message stored in a prerecorded voicemail message data structure;
retrieve the specific voicemail message from the prerecorded voicemail message data structure; and
play the specific voicemail message to the calling party.

18. The system of claim 17, wherein the instructions further cause the processor to:
responsive to playing the specific voicemail message to the calling party, determine if the calling party intends to leave a message for the recipient; and
responsive to an indication that the calling party intends to leave the message, record the message from the calling party in a voice message data structure.

19. The system of claim 15, wherein the indication is received via at least one of a touch pad indication of an on-screen menu on the recipient device or a hotkey associated with a key on a keypad of the recipient device.

20. The system of claim 15, wherein the indication is received via a hotkey associated with a key on a keypad of the recipient device.
